(19) United States
(12) Patent Application Publication
(10) Pub. No.: US 2013/0198090 A1
(43) Pub. Date: Aug. 1, 2013

(54) ENFORCING RULE COMPLIAINCE WITHIN AN ONLINE DISPUTE RESOLUTION SESSION

(71) Applicant: SIM J. SINGH, MIRAMAR, FL (US)

(72) Inventor: SIM J. SINGH, MIRAMAR, FL (US)

(21) Appl. No.: 13/359,569

(22) Filed: Jan. 27, 2012

(51) Int. Cl. G06Q 10/00

(52) U.S. Cl. 705/309

(57) ABSTRACT

An online dispute resolution (ODR) engine can be able to facilitate a caucus within an alternative dispute resolution of an online dispute resolution session between a neutral participant, a caucused participant, and a non-caucused participant. The alternative dispute resolution can be associated with at least one legal case. A data store can be configured to persist one or more rules associated with the alternative dispute resolution, a legal case, and a compliance artifact. The rules can be a law and a legally binding requirement. The legal case can be a civil or criminal case. The compliance artifact can include a mandatory item associated with the rules and the legal case.

### BACKGROUND

The present invention relates to the field of online dispute resolution and, more particularly, to enforcing rule compliance within an online dispute resolution session.

Alternative Dispute Resolution (ADR) can include dispute resolution processes and techniques which act as a means for disagreeing entities to come to an agreement in lieu of litigation (e.g., formal judicial processes). Despite historic resistance to ADR, ADR has gained widespread acceptance among both the general public and the legal profession in recent years. Recently, some courts require certain entities to resort to ADR (e.g., mediation) before permitting the entities' case to be tried. The rising popularity of ADR can be explained by the increasing caseload of traditional courts, the realization that ADR imposes fewer costs than litigation, a preference for confidentiality, and the desire for entities to have greater control over the selection of the individual who arbitrate their dispute. Although ADR has proven to be a valuable, many shortcomings still exist (e.g., physical meetings, scheduling), which limit its use. To address these shortcomings, online dispute resolution (ODR) is frequently utilized.

Currently, ODR involves reuse of basic traditional Information and Communication Technologies (ICT) to perform ADR processes. For example, telephone calls are used to aid in ADR when a participant cannot be physically present. It is not uncommon for ODR to involve Web conferencing technologies to allow remote entities to participate in an ADR. However, these technologies are general purpose technologies and often do not provide essential features which can facilitate ADR processes. For example, there currently exist no ODR technologies which guide participants (e.g., mediator guidance) through an ADR process. Further, ODR frequently lacks oversight which can be necessary to ensure ADR processes are conducted in an appropriate manner (e.g., ADR protocols are followed).

### BRIEF SUMMARY

One aspect of the present invention can include a method, computer program product, an apparatus, and a system for enforcing rule compliance within an online dispute resolution session. An online dispute resolution (ODR) engine can be able to facilitate a caucus within an alternative dispute resolution of an online dispute resolution session between a neutral participant, a caucused participant, and a non-caucused participant. The alternative dispute resolution can be associated with a legal case. A data store can be configured to persist one or more rules associated with the alternative dispute resolution, the legal case, and a compliance artifact. The rules can be a law or a legally binding requirement. The legal case can be a civil or criminal case. The compliance artifact can include a mandatory item associated with the rules and the legal case.

Another aspect of the present invention can include a computer program product, an apparatus, a system, and a method for enforcing rule compliance within an online dispute resolution session. An online dispute resolution session associated with an alternative dispute resolution can be identified. The alternative dispute resolution can be associated with a legal case. The legal case can be associated with one or more rules. The rules can be a law and a legally binding requirement. A rule compliance action can be performed upon a selected rule of the rules to determine the selected rule is satisfied. When the selected rule is satisfied, a neutral participant participating in the online dispute resolution session can be optionally alerted that rule compliance is met. When the selected rule is not satisfied, a functionality of the online dispute resolution session previously available to the neutral participant can be disabled or reminders for compliance can be sent to session participants.

### BRIEF DESCRIPTION OF THE SEVERAL VIEWS OF THE DRAWINGS

FIG. 1 is a schematic diagram illustrating scenario for enforcing rule compliance within an online dispute resolution session in accordance with an embodiment of the inventive arrangements disclosed herein.

FIG. 2A is a schematic diagram illustrating a method for enforcing rule compliance within an online dispute resolution session in accordance with an embodiment of the inventive arrangements disclosed herein.

FIG. 2B is a schematic diagram illustrating a method for enforcing rule compliance within an online dispute resolution session in accordance with an embodiment of the inventive arrangements disclosed herein.

FIG. 3 is a schematic diagram illustrating a system for enforcing rule compliance within an online dispute resolution session in accordance with an embodiment of the inventive arrangements disclosed herein.

FIG. 4 is a schematic diagram illustrating an embodiment for enforcing rule compliance within an online dispute resolution session in accordance with an embodiment of the inventive arrangements disclosed herein.

FIG. 5 is a schematic diagram illustrating a mediator screen associated with an interface for enforcing rule compliance within an online dispute resolution session in accordance with an embodiment of the inventive arrangements disclosed herein.

FIG. 6 is a schematic diagram illustrating a plaintiff screen associated with an interface for enforcing rule compliance within an online dispute resolution session in accordance with an embodiment of the inventive arrangements disclosed herein.

FIG. 7 is a schematic diagram illustrating a mediator screen in a caucus session with a plaintiff associated with an interface for enforcing rule compliance within an online dispute resolution session in accordance with an embodiment of the inventive arrangements disclosed herein.

FIG. 8 is a schematic diagram illustrating a plaintiff screen in a caucus session with a mediator associated with an interface for enforcing rule compliance within an online dispute resolution session in accordance with an embodiment of the inventive arrangements disclosed herein.

FIG. 9 is a schematic diagram illustrating a defendant screen during a caucus between a plaintiff and a mediator associated with an interface for enforcing rule compliance within an online dispute resolution session in accordance with an embodiment of the inventive arrangements disclosed herein.

### DETAILED DESCRIPTION

The present disclosure is a solution for enforcing rule compliance within an online dispute resolution session. In the solution, an online dispute resolution (ODR) engine can facilitate alternative dispute resolution processes through rule compliance monitoring. Monitoring can be performed during an online session associated with an ODR capable system. The ODR system can permit unified dispute resolution services to enable rapid legal case resolutions. For example, an arbitrator can utilize the ODR system to find and handle an out of court settlement case. The ODR system functionality can include audio/video capabilities, caucus functionality, facilitator matching abilities, recommendation services, scheduling, oversight, and the like. The ODR system can utilize rules associated with the legal case and/or a geographic region (e.g., jurisdiction) to ensure appropriate outcomes. In one instance, participants can be presented with a compliance artifact (e.g., checklist) of mandatory items which must be satisfied during the session. In the instance, adherence to mandatory items can be enforced through one or more mechanisms. That is, clear objectives for the online session can be defined enabling participants to easily understand and conform to alternative dispute resolution processes.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

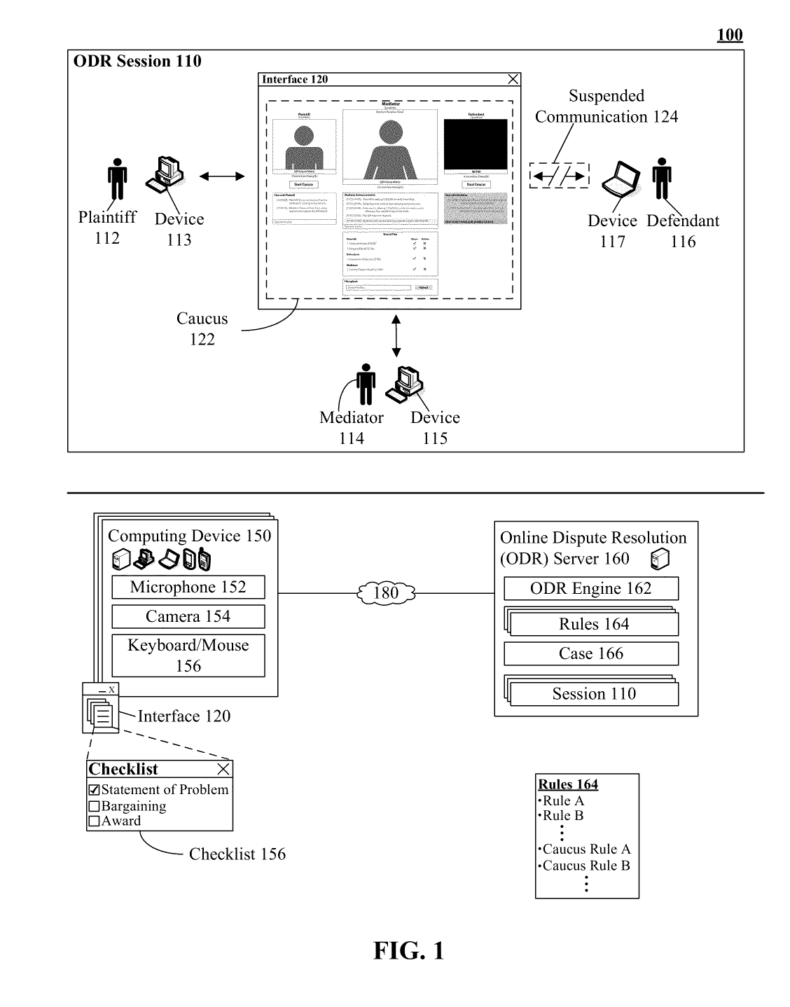

FIG. 1 is a schematic diagram illustrating scenario 100 for enforcing rule compliance within an online dispute resolution session in accordance with an embodiment of the inventive arrangements disclosed herein. Scenario 100 can be performed in the context of method 200A, 200B, system 300, embodiment 400, and screens 500-900. In scenario 100, an alternative dispute resolution (ADR) process can be performed within an online dispute resolution (ODR) session 110 in accordance with rules 164. As used herein, ADR can include, but is not limited to, mediation, arbitration, negotiation, and the like. ODR can include, but is not limited to, an ADR process facilitated by technology to resolve disputes between participants. Participants can include, but is not limited to, individuals, organizations, associations, business entities, governmental agencies, (in the public international law context) states, and the like. For example, scenario 100 illustrates an ODR session occurring over the Internet between geographically distinct participants: a plaintiff, a defendant, and a mediator. That is, the disclosure can provide a live video session for mediation and/or arbitration which can allow plaintiffs and defendants to virtually meet using traditional technologies (e.g., webcams).

As used herein, the ODR session 110 can include a plaintiff 112, mediator 114, defendant 116, and the like. The plaintiff 112, mediator 114, and defendant 116 can utilize devices 113, 115, 117 to participate in session 110. It should be appreciated that session 110 can include multiple participants and is not limited to three participating entities. For example, session 110 can include two plaintiffs 112 utilizing two separate devices, a mediator 114 using device 115, and a defendant 116 interacting with device 117. Session 110 can be utilized to resolve a dispute (e.g., case 166) between a plaintiff 112 and a defendant 116 which can be facilitated by a mediator 114. For example, the dispute can be a case 166 which can be a property dispute between a plaintiff 112 and a defendant 116.

In the disclosure, engine 162 can utilize rules 164 to generate a checklist 156. For example, Rule A of rule 164 can correspond to a “statement of problem” item of checklist 156. Rules 164 can include guidelines which can govern ODR activities. For example, rule 164 can include arbitration award guidelines which a mediator 114 must follow for the ODR session to have merit. Checklist 156 can be presented within session 110 (e.g., interface 120) which can aid participants in resolving case 166. For example, checklist 156 can include major stages of a mediation process. That is, checklist 156 can help guide participants to resolving case 166 as easily as traditional ADR techniques. Engine 162 can be utilized to enforce appropriate rules 164 to ensure session 110 is conducted according to ODR and/or ADR protocols. In one instance, session 110 can be terminated only when each item on the checklist 156 is completed. In the instance, a warning notification can be presented when a participant attempts to terminate the session prior to checklist 156 completion. For example, if a defendant tries to leave the session a “failure to comply” notification can be presented alerting the defendant of potential liability.

As used herein, mediator 114 can be an exemplary neutral participant. Neutral participant can be an arbitrator, a mediator, a judge, a negotiator, a peacekeeper, and the like. Plaintiff 112 can be a participant associated with case 166 which seeks an equitable resolution to damages incurred by a defendant 116. Defendant 116 can be a participant formally charged with causing damages to the plaintiff 112. Plaintiff 112 and defendant 116 can agree to resolve case 166 via online dispute resolution (e.g., session 110) involving a mediator 114. It should be appreciated plaintiff 112, mediator 114, and defendant 116 can be geographically distributed or clustered. For example, plaintiff 112 and defendant can reside in Phoenix and mediator 114 can be located in Seattle. Plaintiff 112, mediator 114, and defendant 116 can be communicatively linked via one or more wired and/or wireless networks (e.g., network 180). It should be understood that, the disclosure can support co-mediation and/or mediation observation scenarios.

Session 110 can include traditional teleconferencing interactions such as audio, video, text, and the like. Session 110 can be presented within interface 120 in which participants 112, 114, 116 can interact. For example, interface 120 can be a Web browser presenting a video conferencing communication of session 110. It should be appreciated that interface 120 in session 110 can present an exemplary screen which participants 112, 114, 116 can view. For example, interface 120 can present a view similar to screen 500. That is, participants can share similar views and/or different views which can change based on participant (e.g., mediator 114) actions. For example, each participant can have a different view (e.g., screen 700, 800, 900) when a caucus 122 is in progress.

Session 110 can include a caucus 122 between a plaintiff 112 and a mediator 114 which can be performed during the session 110. For example, a mediator 114 can initiate a caucus 122 between the plaintiff 112 and the mediator 114 when private communication is necessary. Caucus 122 can mimic physical caucus limitations which enable participants to communicate in a confidential manner. That is, participants not involved in the caucus 122 can be excluded from online communication occurring between caucus 122 participants. For example, suspended communication 124 can occur when mediator 114 initiates a caucus with plaintiff 112. That is, defendant 116 cannot see or hear communication occurring between caucus 122 participants (e.g., screen 900) and the defendant 116 cannot communicate to caucus 122 participants.

Computing device 150 can be an example of a computing device which can be utilized to participate in session 110. For example, device 113, 115, 117 can conform to computing device 150. Device 150 can include a microphone, camera, keyboard/mouse 156, interface 120, and the like. That is, device 150 can include components for audio/visual communication, textual communication, and the like. Device 150 can be communicatively linked to an online dispute resolution (ODR) server 160 via network 180. Device 150 can include accessibility components for disabled and/or special needs participants. For example, device 150 can include a telecommunications device for the deaf (TTD) component.

Online dispute resolution (ODR) server 160 can provide computing resources for session 110. For example, server 160 can host session 110 providing an independent resource to conduct alternative dispute resolution processes. Server 160 can be an exemplary computing resource utilized in enabling rule driven online dispute resolution. In one instance, server 160 can include ODR engine 162, rules 164, case 166, and session 110. In the instance, server 160 components can permit session 110 to be executed in accordance to rules 164. In one instance, engine 162 can provide conformance to ODR Standards of Practice. Standards of Practice can include, but is not limited to Standards of Practice associated with the American Bar Association, National Centre for Technology and Dispute Resolution Standards of Practice, US Federal Trade Commission Standards of Practice, Department of Commerce Standards of Practice, Global Business Dialogue on Electronic Commerce Standards of Practice, and the like. In one instance, engine 162 can assist ADR processes to result in enforceable awards. For example, engine 162 can be utilized to produce a case 166 outcome which can be enforced via New York Convention on the Recognition and Enforcement of Foreign Arbitral Awards. That is, engine 162 can enable session 110 to be conducted in compliance with state, federal, and/or international codes of conduct. Further, engine 162 can enforce rules for ADR stemming from established procedural laws.

Rules 164 can be associated with a public law, a private law, a guideline, a Web site policy, and the like. For example, rules 164 can include a caucus rule (e.g., Caucus Rule A) which mandate participants to behave appropriately during a caucus. Rules 164 can be manually and/or automatically established. Rules 164 can be associated with case 164 jurisdiction, participant jurisdiction (e.g., mediator 114 jurisdiction), and the like. In one instance, rules 164 can be laws which can be utilized to create one or more checklist items. In the instance, engine 162 can ensure appropriate laws associated with case 166 and/or ODR are satisfied. It should be appreciated that during session 110 rules 164 can dynamically change as the dispute resolution progresses.

In one embodiment, ODR engine 162 can automatically ensure rule 164 compliance during session 110. In the embodiment, engine 162 can monitor participant interaction to determine when a checklist 156 item has been satisfied and automatically indicate successful completion (e.g., check mark). In another embodiment, ODR engine 162 can periodically monitor items on checklist 156 to determine if the items have been satisfied. In the embodiment, based on the determination, the engine 162 can generate appropriate notifications based on participant interaction, dispute resolution stage, and the like. For example, when a mediator 114 checks off an item on checklist 156, a notification of item completion can be presented to each participant. It should be understood that engine 162 can provide tools (e.g., user interface tools) which can enhance traditional ODR sessions. For example, ODR engine 162 can present a settlement calculator which can assist an arbitrator in determining an appropriate settlement value for each participant.

Drawings presented herein are for illustrative purposes only and should not be construed to limit the invention in any regard. It should be appreciate that due to the sensitive nature of information exchanged within the session 110, security measures can be in place at every level (e.g., application, communication, etc.) of the disclosure (e.g., scenario 100). During session 110, communication between device 150 and server 160 can be securely exchanged utilizing one or more traditional and/or proprietary mechanisms. For example, audio/video communication between device 150 and server 160 can be encrypted. It should be appreciated that checklist 156 is an exemplary form of rule compliance and can vary based on implementation requirements. In one embodiment, rules 164 can be compiled into an agenda which can be presented within interface 120. For instance, agenda can include mandatory and/or non-mandatory items which can be reviewed during the session. It should be appreciated that in one instance, session 110 can lack rules 164.

It should be appreciated that the disclosure can include, but is not limited to, Internet Dispute Resolution (iDR), Electronic Dispute Resolution (eDR), Electronic ADR (eADR), Online ADR (oADR), and the like. It should be appreciated that session 110 can be binding or non-binding. In one instance, ODR session can include consensual methods or adjudicative methods. Consensual methods can include automated and/or assisted processes. Automated processes can include Double Blind Bidding, Visual Blind Bidding, and the like. Assisted processes can include evaluative actions, reference actions, and the like.

It should be appreciated that the disclosure can be utilized as tiered approach to resolving a dispute associated with case 166. It should be appreciated that case 166 can include legal (e.g., civil and criminal cases) and non-legal cases. It should be understood that the disclosure can be leveraged in multiple ways and is not limited in this regard. In one scenario, the disclosure can be utilized for satisfying an ADR clause of a contract. In the scenario, clause stipulations can be rules 164 which can be inputted into the engine 162 to enable conformance with the clause. Further, the disclosure can be utilized in Federal Diversity Cases in which parties of a dispute are completely diverse to ease the burden of traditional courts. In yet another use case, the disclosure can permit mock mediation/arbitration to be performed. For example, academic institutions can utilize the disclosure for simulating real world disputes and re-enforcing appropriate participant behaviors.

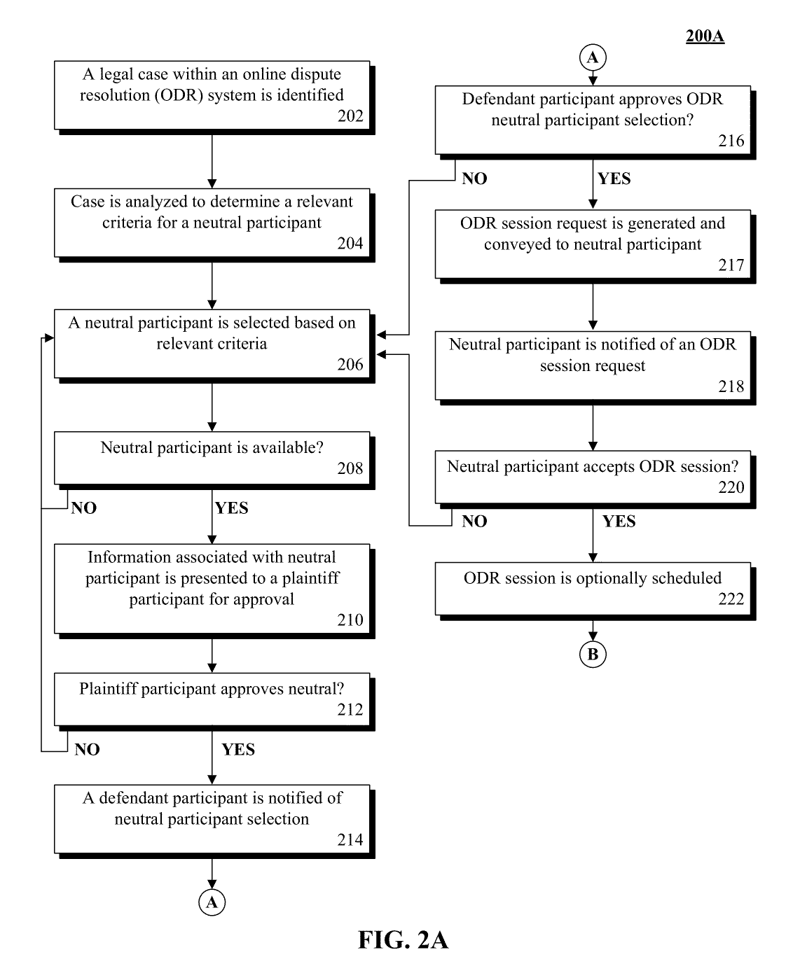

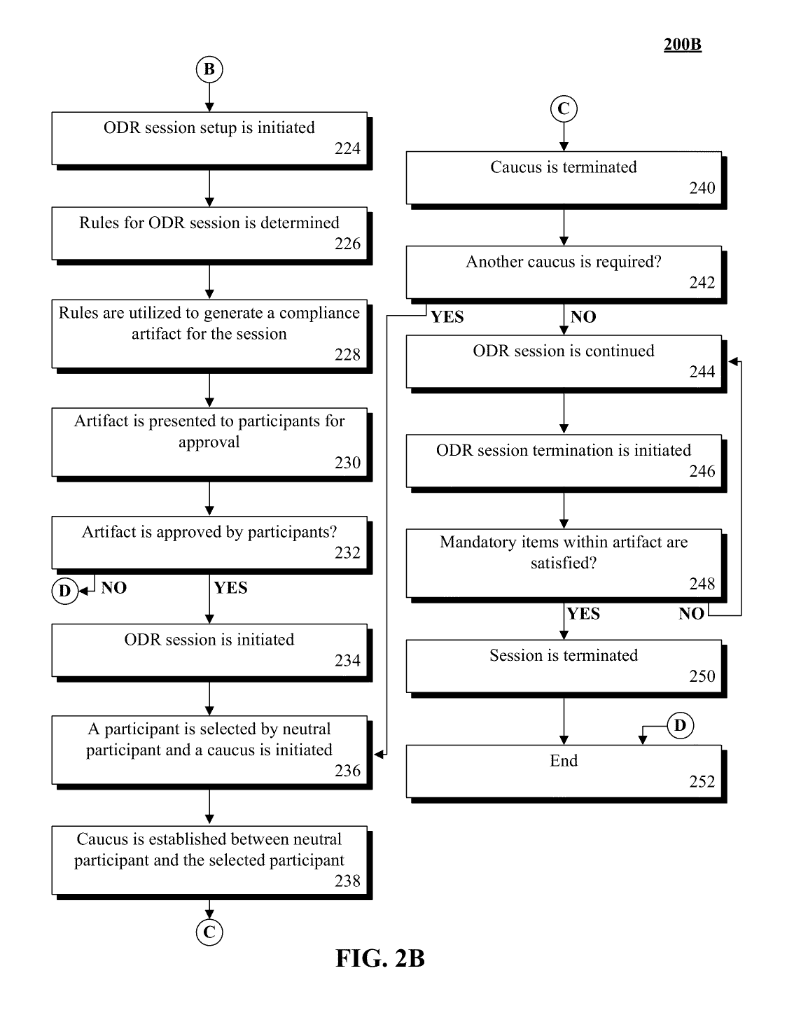

FIGS. 2A, 2B is a schematic diagram illustrating a method 200A for enforcing rule compliance within an online dispute resolution session in accordance with an embodiment of the inventive arrangements disclosed herein. Method 200A, 200B can be performed in the context of scenario 100, system 300, embodiment 400, and screens 500-900. In method 200A, a plaintiff and a defendant associated with a dispute can be appropriately matched with a mediator who can facilitate a resolution to the dispute. The matching can produce a scheduled online dispute resolution session in which plaintiff, defendant, and mediator can communicate to resolve the dispute. It should be appreciated that the method describes a plaintiff centric process, but can include mediator driven and/or defendant initiated processes.

In step 202, a legal case within an online dispute resolution (ODR) system can be identified. Identification can be automatically and/or manually triggered. For example, a user (e.g., a plaintiff) of the ODR system can select a case associated with a dispute for resolution. In step 204, the case can be analyzed and relevant criteria for selecting a neutral participant (e.g., mediator, arbitrator) can be determined. Criteria can be determined based on case data, user preferences, and the like. Criteria can include, but is not limited, case type, case jurisdiction, pricing, availability, expertise, and the like. In step 206, a neutral participant can be selected based on the relevant criteria. For example, when the case type is associated with harassment, mediator “Mark Messier” can be selected from directory 472 based on expertise criteria. In one instance, a neutral participant can be selected randomly from a directory (e.g., directory 472). For example, when participants cannot agree on a mediator an appropriate mediator can be randomly selected and presented to the participants. In another instance, multiple neutral participants can be selected based on the criteria. For example, a listing of the top ten neutral participants which match the criteria can be presented. In step 208, if the neutral participant is available, the method can continue to step 210, else return to step 206. In step 210, information associated with the neutral participant can be presented to a plaintiff participant for approval. Information can be presented within a traditional and/or non-traditional notification. For example, information can be presented within an electronic mail which can permit the plaintiff to automatically approve the neutral participant selection.

In step 212, if the plaintiff participant approves the neutral participant, the method can continue to step 214, else return to step 206. In step 214, a defendant participant can be notified of neutral participant selection. Notification can include traditional and/or proprietary notification mechanisms. For example, notification can include an automated telephone message which can permit the defendant to confirm or reject selection. In step 216, if the defendant approves the neutral participant selection the method can continue to step 217, else return to step 206. In one instance, the defendant can be assigned a neutral participant. In the instance, the assignment can be an automated process or a manual action. In step 217, an ODR session request can be generated and conveyed to the neutral participant. In step 218, the neutral participant can be notified of an ODR session request. For example, neutral participant can be notified by a Short Message Service (SMS) message, email, telephone call, fax, system notification or a combination thereof allowing the neutral participant to accept or deny the session request. In step 220, if the neutral participant accepts the ODR session request, the method can continue to step 222, else return to step 206. In step 222, the ODR session can be optionally scheduled. In one instance, when participant availability is limited, a session can be optionally scheduled for a subsequent time. For example, based on availability of plaintiff, defendant, and/or neutral participant, an appropriate date and time can be automatically selected for the session. In another instance, an ODR session can be immediately initiated when participants are available. For example, when each participant is online, each participant can receive an invitation for an ODR session and the session can commence upon acceptance of the invitation. It should be appreciated that before an ODR session can be initiated, participants must agree to forego physical presence requirements defined by state, federal, and/or international law for conducting ADR. That is, participants can be presented with a mandatory terms of service notification which must be accepted for the ODR session to be initiated.

Step 222 of method 200A can continue to step 224 of method 200B. In method 200B, an online dispute resolution session can be established to resolve the dispute between participants (e.g., plaintiff and defendant). The session can be conducted utilizing a compliance artifact (e.g., checklist) which can enforce rule compliance for the session. It should be appreciated that steps 236-240 can be optional steps of method 200B.

In step 224, an ODR session setup can be initiated. Initiation can include, but is not limited to, authentication, verification, disclaimer presentation, terms of service presentation, and the like. In step 226, rules for the ODR session can be determined. Rules can be determined based on data including, but not limited to, case type, case jurisdiction, participant jurisdiction, and the like. It should be appreciated that rules be created from any combination of the preceding data. In one instance, ODR session can be determined to lack rules. In the instance, steps requiring rule evaluation (e.g., steps 228-232) can be omitted. In step 228, rules can be utilized to generate a compliance artifact for the session. In step 230, the compliance artifact can be presented to each participant for approval. It should be appreciated that step 230, 232 can be optional steps of method 200B. In step 232, if the compliance artifact is approved by participants, the method can continue to step 234, else proceed to step 252. In step 234, the ODR session can be initiated. Initiation can include presentation of audio/video streams, system announcements, user interface initialization, and the like.

In step 236, a participant can be selected by the neutral participant and a caucus can be initiated. In step 238, a caucus can be established between the neutral participant and the selected participant. During the caucus, neutral participant and selected participant can communicate privately. Caucus duration can be unlimited, limited by rules (e.g., checklist, agenda), limited by system preferences, and the like. In step 240, the caucus can be terminated. Termination can include manual and/or automatic termination. In step 242, if another caucus is required, the method can return to step 236, else continue to step 244. In one embodiment, upon termination of the caucus the participant previously in the caucus can be presented with admission information. In the embodiment, a notification with information which can and/or cannot be revealed to a non-caucused participant can be presented. It should be appreciated that the embodiment can be considered an application for a rule. That is, the disclosure can assist in guiding participants in appropriate use of caucus procedures.

In step 244, the ODR session can continue. Duration can be unlimited, limited by rules (e.g., checklist, agenda), limited by case specifics (e.g., court ordered settlement), limited by system preferences, and the like. In one instance, ODR session can persist until a resolution to the case (e.g., dispute resolved) is reached. In the instance, session can be suspended permitting participants to take a recess break during the session. For example, a mediator can recess the session for fifteen minutes allowing participants to reorganize arguments privately or resume the session at a later time.

In step 246, ODR session termination can be initiated. In step 248, if mandatory compliance artifact items are satisfied, the method can continue to step 250, else return to step 244. In step 250, session can be terminated. In one instance, upon termination, relevant settlement documentation can be generated for relevant participants. In step 252, the method can end.

It should be appreciated that the disclosure can be associated with user feedback mechanisms permitting neutral participants to continually improve ADR skills. For example, when an arbitration session ends, participants can be encouraged to make private comments about an ODR session can be viewable by an arbitrator upon completion of the ODR session.

Drawings presented herein are for illustrative purposes only and should not be construed to limit the invention in any regard. It should be appreciated that method 200A, 200B can be performed in real-time and/or near real-time. It should be understood that method 200A, 200B can be performed in parallel and/or in serial. It should be appreciated that method 200A, 200B can be performed separately.

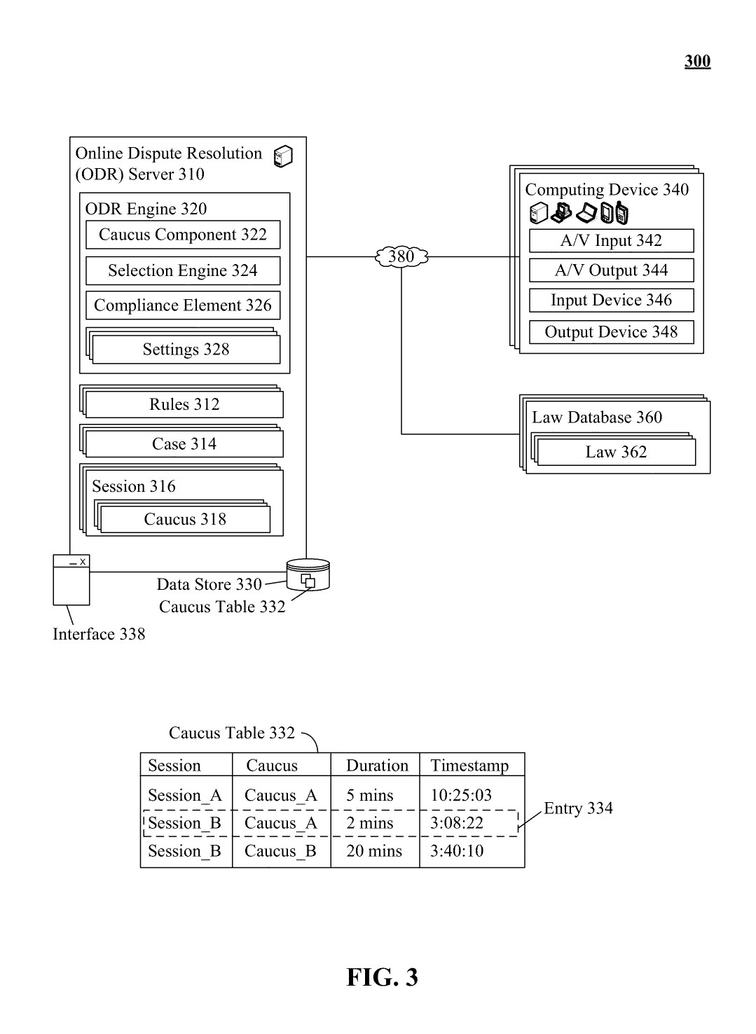

FIG. 3 is a schematic diagram illustrating a system 300 for enforcing rule compliance within an online dispute resolution session in accordance with an embodiment of the inventive arrangements disclosed herein. System 300 can be present in the context of scenario 100, method 200A, 200B, embodiment 400, and screen 500-900. In system 300, an online dispute resolution (ODR) engine 310 can utilize law 362 to govern an online dispute resolution session 316. In one embodiment, engine 310 can identify relevant law 362 associated with case 314 to create rules 312. Rules 312 can be employed during session 316 to enforce compliance with law 362. That is, engine 320 can provide features which traditional online dispute resolution systems lack.

In system 300, a computing device 340 can be utilized by participants to perform an online dispute resolution session 316. For example, a plaintiff, a defendant, and a neutral participant (e.g., arbitrator) can each utilize a device 340 to resolve case 314. Computing device 340 can be communicatively linked to an online dispute resolution server 310 which can perform ODR functionality associated with session 316. It should be appreciated that system 300 can include optional components not presented herein. System 300 can be communicatively linked via network 380.

Online dispute resolution (ODR) server 310 can be a hardware/software element configured to provide a robust online dispute resolution environment. Server 310 functionality can include, but is not limited to, file serving, notification capabilities, metric collection, metric analysis, billing functionality, scheduling capabilities, directory services, documentation generation, and the like. Server 310 can perform traditional functionality including, but not limited to, organizing information, sending automatic responses, assist in shaping writing communications (e.g., blocking foul language/inappropriate comments), and the like. In addition, the server 310 can monitor participant performance, schedule meetings, clarify participant interests, and/or manage participant priorities. Server 310 can include, but is not limited to, ODR engine 320, rules 312, case 314, session 316, data store 330, interface 338, and the like. In one instance, server 310 can be a networked computing element geographically distributed throughout a distributed computing environment. In another instance, server 310 can be a distributed computing element within a networked computing environment.

Engine 320 can be a hardware/software component able to enhance traditional online dispute resolution by providing participant tools (e.g., user interface tools) and/or services currently absent. Engine 320 functionality can include, but is not limited to, case 314 management, rule 312 creation, session 316 management, device 340 management, database 360 selection, law 362 analysis, and the like. Engine 320 can be utilized to manage audio/video/text communication associated with session 320. For example, engine 320 can include Session Initiated Protocol (SIP) functionality. Engine 320 can include, but is not limited to, caucus component 322, selection engine 324, compliance element 326, settings 328, and the like. In one embodiment, engine 320 functionality can be available as a Web-enabled service. In the embodiment, one or more payment schemes can be associated with provided functionality. That is, engine 320 can be leveraged to monetize the disclosure.

Caucus component 322 can be a hardware/software element configured to manage a caucus within session 316. Component 322 functionality can include, but is not limited to, caucus 318 creation, caucus 318 tracking, caucus 318 termination, and the like. Component 322 can utilize table 332 to monitor a caucus 318 within session 316. Table 332 can include, but is not limited to, a session identifier, a caucus 318 identifier, a duration, a timestamp, and the like. Table 332 can be automatically generated when a caucus 318 is established and persistently updated during a caucus 318 lifetime. For example, entry 334 can be utilized to monitor the duration of a caucus 318 (e.g., Caucus_A) within a session 316 (e.g., Session_B). It should be appreciated that component 322 can track multiple caucuses within a single session 316.

Selection engine 324 can be a hardware/software component for choosing a neutral participant for session 316. Engine 324 functionality can include, but is not limited, criteria selection determination, search engine capabilities, selection confirmation, and the like. In one instance, engine 324 can permit manual searching of a neutral participant directory. In the instance, engine 324 can process keyword input from a user to enable searching. In another instance, engine 324 can permit presentation of neutral participant information including, but not limited to, name, credentials, costs, rating, and the like. In one embodiment, engine 324 can perform notification and selection capabilities. In the embodiment, engine 324 can notify a user of multiple neutral participants matching a search query permitting selection of a preferred neutral participant. For example, engine 324 can present a listing of five neutral participants matching a search query within interface 338. In one instance, engine 324 can support neutral participation substitution during a session 316. In the instance, engine 324 can permit a neutral participant to select an appropriate substitute based on relevant criteria. For example, in extenuating circumstances when a mediator cannot continue a session, engine 324 can permit a real-time substitution of a different mediator to occur allowing the session to progress without significant interruption.

Compliance element 326 can be hardware/software entity for ensuring rule 312 compliance during session 316. Element 326 functionality can include, rule 312 selection, compliance artifact (e.g., checklist, agenda) generation, compliance artifact verification, and the like. Compliance element 326 can ensure rule compliance within a session and/or a caucus 318. In one instance, element 326 can provide settlement guidance to participants via one or more notifications. In one configuration of the instance, historic cases (not shown) from a database (e.g., database 360) can be leveraged to present average settlement values based on case type. For example, during a bargaining stage of a mediation, a mediator can be presented with a recommendation for a settlement value based on outcomes of historic cases. In another configuration of the instance, participants can be presented with suggestions to help the participants reach an equitable resolution. It should be appreciated that compliance element 326 can automatically log compliance checkpoints to permit robust auditing processes.

In one instance, element 326 can assist a neutral participant in resolving conflicting rules (e.g., conflicting laws) associated with case 314. In the instance, element 326 can automatically and/or manually (e.g., user initiated action) provide recommendations to a neutral participant during a session/caucus. For example, element 326 can present (e.g., via output device 348) a solution to a neutral participant for resolving a dispute resulting from differing jurisdictions associated with a plaintiff and a defendant.

In one embodiment, the system 300 can permit grievances to be filed by participants against a neutral participant. In the embodiment, the system 300 can enable auditing actions to be executed automatically and/or manually. In one instance, if misconduct by a neutral participant is determined, the account of the neutral participant can be disabled or suspended.

Setting 328 can be one or more rules for configuring the behavior of system 300, server 310, and/or engine 320. Setting 328 can include, but is not limited to, caucus component 322 settings, selection engine 324 options, compliance 326 settings, and the like. In one instance, settings 328 can be presented within interface 338. In the instance, interface 338 can permit user (e.g., administrator) configuration of settings 328. In one embodiment, setting 328 can be used to customize database 360 selection. In the embodiment, selection 360 can be configured by setting 328 to prefer selection based on case 314 type, participant preferences, and the like.

Rules 312 can be one or more conditions which can be satisfied during session 316, caucus 318, and/or after session termination (for example for the case management tool for the Neutral). Rules 312 can be mandatory and/or optional. Rules 312 can follow natural language conventions, proprietary language conventions, and the like. In one instance, rules 312 can be presented within interface 338. In the instance, rules 312 can be managed (e.g., edited) by one or more administrative entities. In one embodiment, rules 312 can include a hierarchy, dependency tree, and the like. For example, rules 312 can include an ordinate rule having three subordinate rules which must be satisfied before the ordinate rule can be satisfied. In one instance, rules 312 can be associated with priority values, ranking values, and the like. In one embodiment, rules 312 can include a special code of e-Ethics which can promote best/fair use practices within the system 300.

Case 314 can be a legal case associated with a dispute between a plaintiff and a defendant. For example, the case 314 can be a civil case such as a lawsuit. In one instance, case 314 can be a criminal case. The dispute can include, but is not limited to, a contract dispute, a property dispute, a labor dispute, a corporate dispute, and the like. Case 314 can include, but is not limited to, case data, case notes, case preferences, and the like. Case data can include, but is not limited to, plaintiff evidence, defendant evidence, and the like. In one instance, case 314 can include multiple cases which are associated with a single dispute. In one instance, case status can be tracked by engine 320 utilizing case table 434. For example, during a session 316, entry 435 can be employed to determine when rules associated with case 314 (e.g., Case_B) are not satisfied (e.g., rules outstanding).

Session 316 can be a semi-permanent interactive information interchange between server 310 and computing device 340. Session 316 can include session data, including, but not limited to, user data, timing information (e.g., duration), state information (e.g., recessed), and the like. Session 316 can include an initiation phase, an authentication phase, termination phase, and the like. Session 316 can be associated with traditional and/or proprietary state tracking mechanisms.

Caucus 318 can be a private session occurring during session 316. Caucus 318 can be an established by a neutral participant during session 316. Caucus 318 can be associated with rules 312 or can lack rules 312. Caucus 318 can include multiple caucuses during session 316. Caucus 318 can be associated with caucus data such as caucus table 332.

Law database 360 can be a data store for persisting law 362. Database 360 can be communicatively linked to server 310 via network 380. Database 360 can include law 362, historic cases (not shown), and the like. Database 360 can include legal databases, case law databases, case files databases, and the like. Law 362 can include public law, private law, case law, and the like. In one instance, database 360 can include public and/or private databases. In the instance, database 360 can be a West Law or Lexis Nexis database and data retained by the system.

It should be appreciated that alternative dispute resolution is traditionally performed in a private environment due to the sensitive nature of the proceedings. As such, engine 320 can be used to permit/restrict device 340 usage based on device 340 type and/or device 340 location. In one embodiment, engine 320 can utilize device information to permit/restrict usage of mobile computing devices. In one configuration of the embodiment, a mobile phone can be blocked from utilizing system 300. In another configuration of the embodiment, engine 320 can restrict mobile device access based on unsecured wireless networks and/or IP addresses. In another configuration of the embodiment, engine 320 can block mobile phone usage based on a user location. In the configuration, presence information (e.g., GPS data) can be leveraged to determine environment setting. For example, when a user is in a public venue such as a coffee shop and attempts to join a session 316, the user can be notified that a mobile phone cannot be used to conduct session 316 due to privacy restrictions associated with the session 316.

Data store 330 can be a hardware/software component able to persist rules 312, case 314, session 316 data, caucus 332, law 362, and the like. Data store 330 can be a Storage Area Network (SAN), Network Attached Storage (NAS), and the like. Data store 330 can conform to a relational database management system (RDBMS), object oriented database management system (OODBMS), and the like. Data store 330 can be communicatively linked to server 310 in one or more traditional and/or proprietary mechanisms. In one instance, data store 330 can be a component of Structured Query Language (SQL) complaint database.

Interface 338 can be a user interactive component permitting interaction and/or presentation of rules 312, case 316, setting 328, and like. Interface 338 can be present within the context of a Web browser application, a desktop application, and the like. In one embodiment, interface 338 can be a screen of online dispute resolution administration tooling. Interface 338 capabilities can include a graphical user interface (GUI), voice user interface (VUI), mixed-mode interface, and the like. In one instance, interface 338 can be communicatively linked to computing device via one or more traditional and/or proprietary mechanisms.

Computing device 340 can be a hardware/software element for receiving and presenting communication associated with session 316. Communication can include, but is not limited to, an audio stream, a video stream, a text input, a text output, a file transfer, and the like. Device 340 can include, but is not limited to, a desktop computer, a laptop computer, a mobile computing device, a tablet computing device, a mobile phone, a portable digital assistant (PDA), a portable music player, and the like. Device 340 can include, but is not limited to, A/V input 342, A/V output 344, input device 346, output device 348, and the like. A/V input 342 can include, but is not limited to, a microphone, a video camera, a still camera, and the like. For example, A/V input 342 can be a camera embedded within a laptop device. A/V output 344 can include, but is not limited to, a loudspeaker, a display, and the like. Input device 346 can include, but is not limited to, physical keyboard, software keyboard, touch screen, mouse, trackpad, tablet, and the like. Output device 348 can include, but is not limited to, projector, printer, and the like.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but is not limited to, bus, star, mesh, and the like. Network 380 types can include, but is not limited to, Local Area Network (LAN), Wide Area Network (WAN), Virtual Private Network (VPN) and the like. Network 380 can include, channel switched network (POTS), packet switched network, and the like.

Drawings presented herein are for illustrative purposes only and should not be construed to limit the invention in any regard. It should be appreciated that system 300 can describe an architecture functionality and system 300 can vary depending on implementation requirements/limitations. It should be appreciated that system 300 can support multiple concurrent sessions 316. In one embodiment, server 310 functionality can be encapsulated within an application programming interface (API). For example, server 310 functionality can be a MICROSOFT .NET framework API. In one embodiment, server 310 can be a cloud computing service. It should be understood that system 300 can support tiered user access including, but not limited to, administrative access, end-user access, support staff access, and the like. In one embodiment, system 300 can provide transcription services. In the embodiment, the system 300 can be automatically triggered to provide a transcript of a session 316 which can be conveyed via one or more communication schemes. For example, a mediator can request a transcript to be mailed to an oversight entity. It should be appreciated that in one embodiment, system 300 can lack rules 312.

It should be appreciated that the disclosure can be implemented utilizing one or more online dispute resolution and/or communication technologies. In one instance, the disclosure can be implemented in one or more computing languages including, but not limited to, C, C++, Practical Extraction and Report Language (PERL), PHP Hypertext Pre-Processor (PHP), JAVA, Active Server Pages (ASP), and the like. It should be appreciated that the disclosure can utilize traditional and/or proprietary audio/video compression to enable maximum availability and/or connectivity.

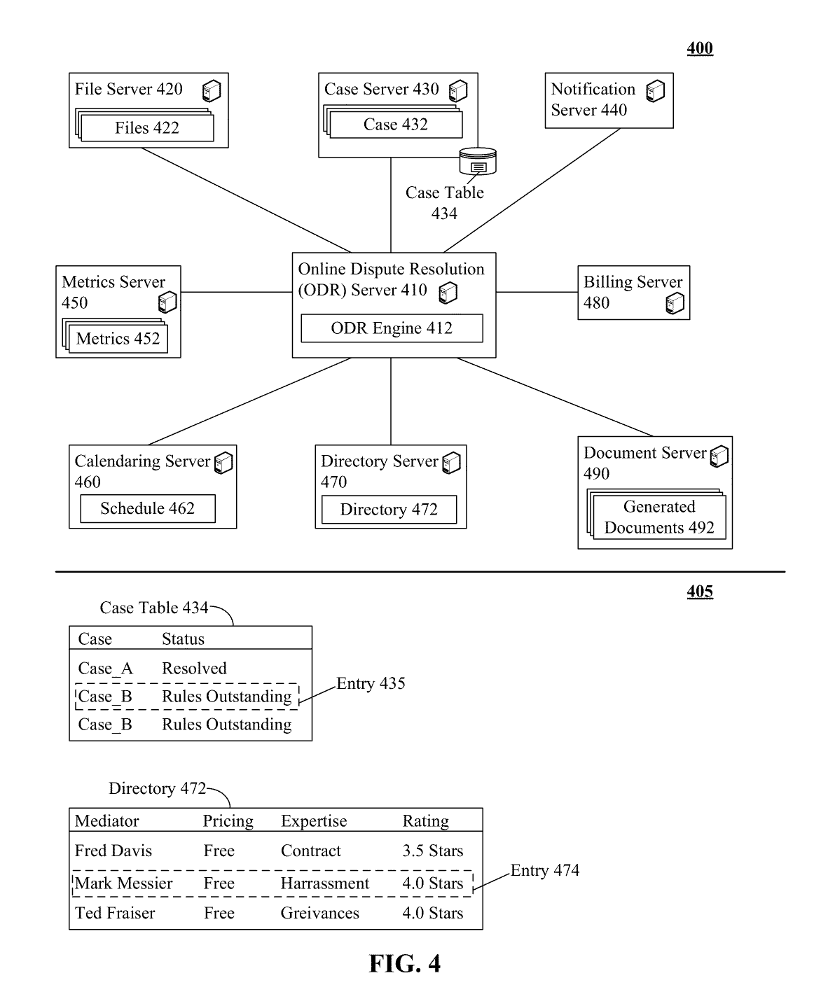

FIG. 4 is a schematic diagram illustrating an embodiment 400 for enforcing rule compliance within an online dispute resolution session in accordance with an embodiment of the inventive arrangements disclosed herein. Embodiment 400 can be present in the context of scenario 100, method 200A, 200B, system 300, and screens 500-900. In embodiment 400, a set of servers 420-490 can be utilized to create a unified online dispute resolution system with rule compliance capabilities. In the embodiment 400, servers 420-490 can be geographically distributed and/or clustered. Embodiment 400 can represent a conventional server computing architecture although non-conventional architectures are contemplated.

Online dispute resolution (ODR) server 410 can be communicatively linked to servers 420-490 via one or more networks. Server 410 can include ODR engine 412 which can communicate with servers 420-490 and/or elements of servers 420-490. For example, engine 412 can access files 422, case 432, metrics 452, schedule 462, directory 472, and generated documents 492 during operations described herein.

Servers 420-490 can include, but is not limited to, file server 420, case server 430, notification 440, metrics server 450, billing server 480, calendaring server 460, directory server 470, document server 490, advertising server (not shown), and the like. Servers 420-490 can be owned and/or operated by one or more individuals, private entities, public entities, and the like. It should be appreciated that embodiment 400 can be include revenue streams from contextual advertising, behavioral advertising, and the like.

File server 420 can permit a session or global based file sharing mechanism. In one instance, server 420 can permit temporary storage of files associated with an ODR session. In one embodiment, server 420 can permit a neutral participant centric private file sharing system to exist amongst participants of an ODR session. In the embodiment, a neutral can publish and/or delete documents to each participant in the ODR session.

Metrics server 450 can permit metrics to be retained for each neutral participant and/or performance. In one instance, custom reporting of neutral participants can be configured. Metrics 452 can include, but is not limited to, average settlement amounts, types of cases handled, success rates, caucus time, repeat business, and the like. In one embodiment, metrics 452 can be leveraged to identify trends within the system. For example, metrics 452 can be analyzed to determine in real-time current popular case types. In one instance, metrics 452 can be available to neutral participants during an ODR session. In the instance, metrics 452 associated with mediation, arbitration, and/or negotiation can be automatically and/or manually presented to aid the neutral participant. For example, a mediator mediating a private injury case can be presented with a notification stating “45% of Mediators Found Splitting the Cost Approach Effective in a Private Injury Case”.

Billing server 480 can support traditional and/or proprietary billing mechanisms. Server 480 can provide support for hourly billing, per session billing, and the like. Further, billing server 480 can be utilized to process payment actions (e.g., credit card payments). In one instance, server 480 can be employed to award a commission to entities providing ODR services via server 410.

In one instance, embodiment 400 can include translation capabilities via a translation entity. Translation entity can include a translation service, a translation by a human agent, and the like. In one instance, embodiment 400 can facilitate live interpreters to assist in an ODR session.

Drawings presented herein are for illustrative purposes only and should not be construed to limit the invention in any regard. In one instance, directory 472 can include neutral participant profiles. In the instance, profiles can include, but is not limited to, a participant history, a picture, ADR style, and the like. In one configuration of the embodiment, certified and non-certified neutral participants can be presented within the same directory 472. In the configuration, a verification system can be present enabling jurisdictionally certified neutral participants to be clearly distinguished within a directory 472 listing. For instance, a special graphic icon can be associated with a visual presentation of a mediator. In another configuration, certified participants and non-certified participants can each be organized in separate directories. In one instance, selection of a non-certified neutral participant can be prefaced by a waiver and/or agreement which must be accepted by each participant of an ODR session. That is, the disclosure can clearly indicate the neutral participant's lack of jurisdictional qualification requirements upon selection.

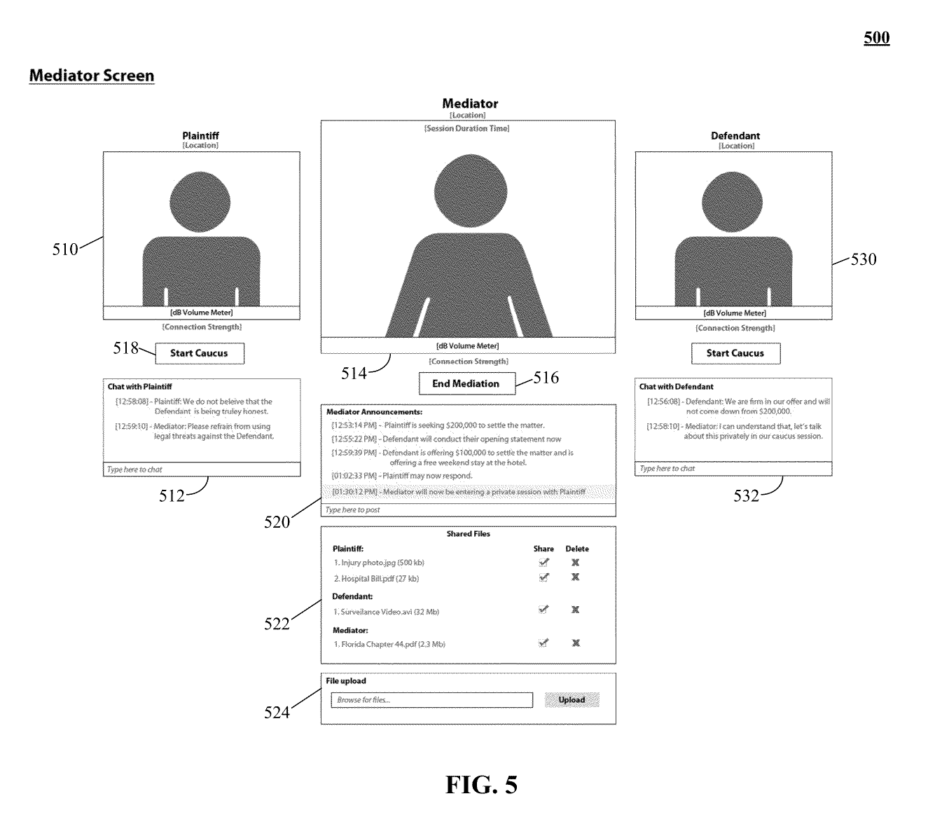

FIG. 5 is a schematic diagram illustrating a mediator screen 500 associated with an interface for enforcing rule compliance within an online dispute resolution session in accordance with an embodiment of the inventive arrangements disclosed herein. Mediator screen can be present in the context of scenario 100, method 200A, 200B, system 300, and embodiment 400. Screen 500 can illustrate a three-way online dispute resolution session associated with screen 600-900. In screen 500, a mediator can be presented an audio/video stream from a plaintiff (e.g., portrait 510), the mediator (e.g., portrait 514), and a defendant (e.g., portrait 530). Screen 500 can allow real-time mediator interaction with a plaintiff, a defendant, and a mediation tool (e.g., file manager 522). Screen 500 can permit a mediator to conduct the online dispute resolution in accordance with a set of rules associated with the session. It should be appreciated that local echo of audio output of a participant can be suppressed in accordance with teleconferencing conventions.

Screen 500 can include portrait 500, 514, 530, chat element 512, 520, 532, mediation control button 516, 518, file manager 522, upload dialog 524, and the like. It should be appreciated that screen 500 can represent an exemplary configuration (e.g., layout) of the disclosure. That is, the interface layout can be customizable (e.g., picture-in-picture) and/or fixed based on implementation requirements. Portrait 510, 514, 530 can conform to traditional teleconferencing conventions. In one instance, each portrait 510, 514, 530 can have a distinct appearance and/or location. In one configuration of the instance, portrait of mediator 514 can be larger than plaintiff and/or defendant and can be positioned in a middle column of a three column view.

Chat element 512, 520, 532 can permit real-time or near real-time text exchange communication between participants. Element 512, 520, 532 can support traditional and/or proprietary messaging actions. In one instance, chat element 520 can be associated with a mediator and can include special functionality different from element 512, 532.

File manager 522 can permit a mediator to share or restrict files associated with the session (e.g., evidence associated with a dispute). In one instance, upload dialog 524 can be utilized to upload a file which can be recognized by manager 522. In the instance, manager 522 can enable a mediator to manage the uploaded file. Management can include traditional and/or non-traditional file operations. In one embodiment, manager can permit peer-to-peer file sharing. In one embodiment, manager 522 and/or dialog 524 can be integrated into a courthouse case management system. For example, manager 522 can permit access to files associated with a dispute registered within a county.

Mediation control button 516, 518 can be a user interactive element able to control session activity. In one instance, button 516 can include start session functionality, recess session capability, end session functionality, start caucus capability, end caucus functionality, and the like. In one embodiment, button 516, 518 can be temporarily disabled when rules associated with the session are not satisfied. In one instance, additional mediation control buttons can be present. In the instance, controls for pausing the mediator audio/video stream can be present.

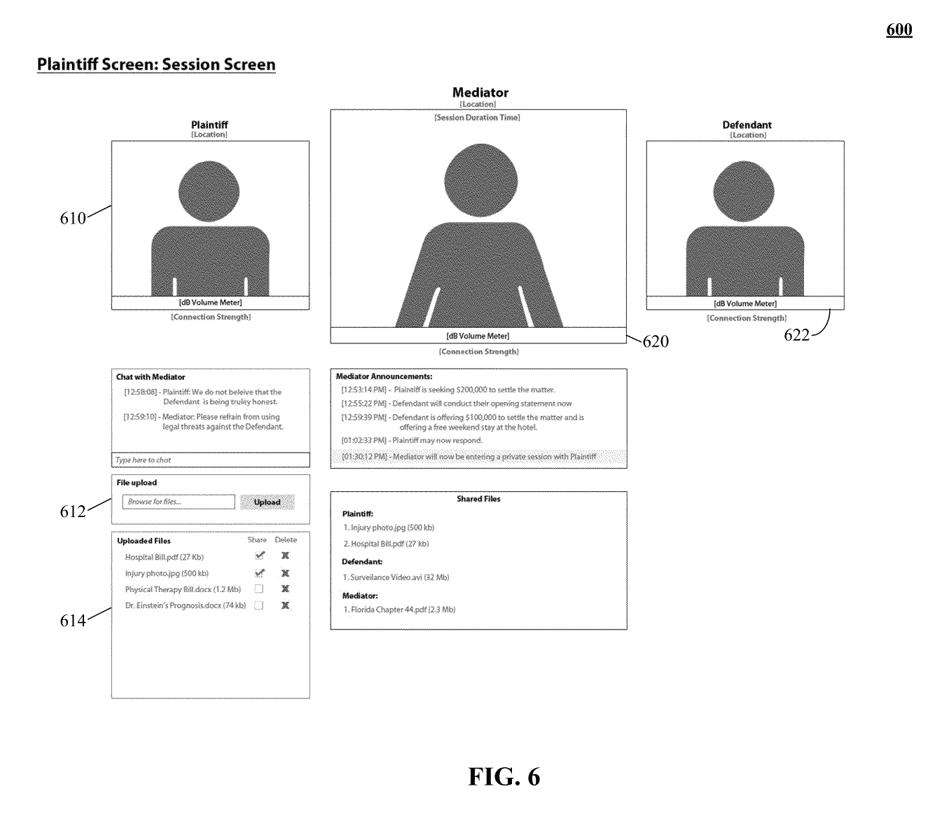

FIG. 6 is a schematic diagram illustrating a plaintiff screen 600 associated with an interface for enforcing rule compliance within an online dispute resolution session in accordance with an embodiment of the inventive arrangements disclosed herein. Plaintiff screen 600 can be present in the context of scenario 100, method 200A, 200B, system 300, and embodiment 400. Screen 600 can illustrate a caucus of a three-way online dispute resolution session associated with a screen 500, 700-900. In screen 600, a plaintiff can be presented an audio/video stream of the plaintiff (e.g., portrait 610), a mediator (e.g., portrait 620), and a defendant (e.g., portrait 622). Screen 600 can allow real-time plaintiff interaction with a defendant and a mediation tool (e.g., upload dialog 612, file manager 614).

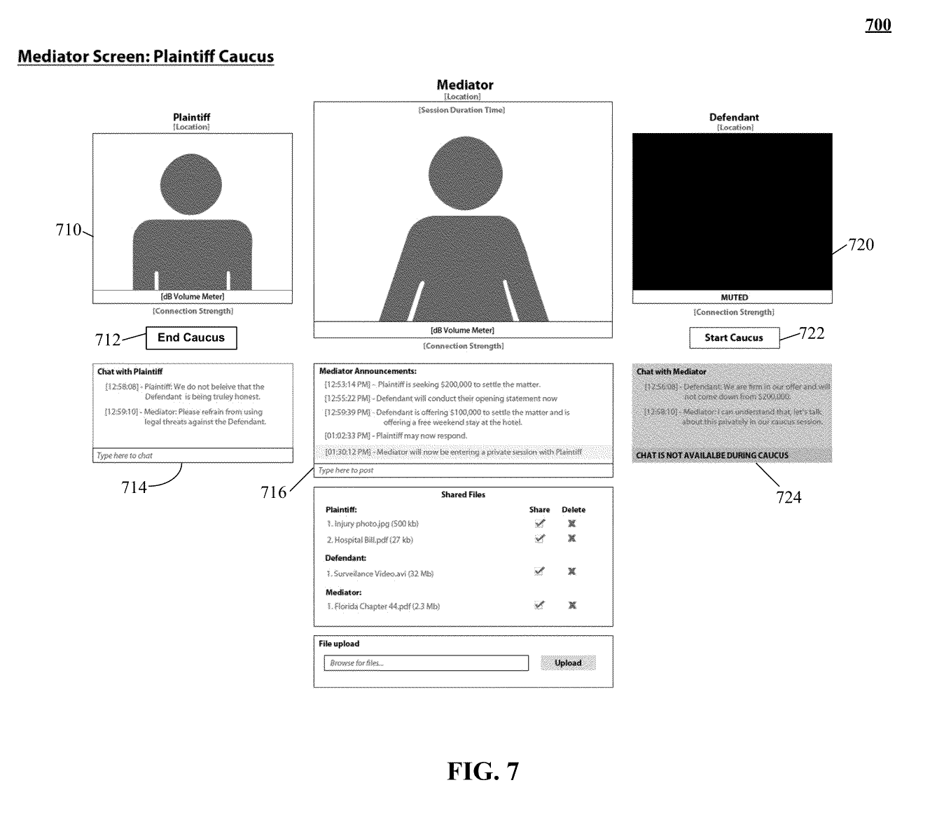

FIG. 7 is a schematic diagram illustrating a mediator screen 700 in a caucus session with a plaintiff associated with an interface for enforcing rule compliance within an online dispute resolution session in accordance with an embodiment of the inventive arrangements disclosed herein. Plaintiff caucus screen 700 can be present in the context of scenario 100, method 200A, 200B, system 300, and embodiment 400. Screen 700 can illustrate a caucus of a three-way online dispute resolution session associated with a screen 500, 600, 800, 900. In screen 700, a mediator can conduct a caucus with a plaintiff via audio/video stream of the plaintiff (e.g., portrait 710). In the caucus, audio/video communication between plaintiff and mediator can be private. In one instance, portrait 720 associated with a defendant can be visually blocked and audio can be muted. Screen 700 can allow real-time mediator interaction with a plaintiff and chat element 716. During the caucus, chat element 716 can permit secure private text exchange between the plaintiff and the mediator. It should be appreciated that chat element 716 can be a component of a mediation tool which can include file sharing capabilities. For the duration of the caucus, a mediation control button 712 can be presented permitting the caucus to be ended. In one instance, a mediation control button 722 can be presented permitting a current caucus with the plaintiff to be terminated and a caucus with the defendant to be established. In the caucus, a plaintiff can communicate privately via text exchange using chat element 714. In one embodiment, chat element 724 can be disabled until the caucus between the plaintiff and the mediator is terminated. That is, the defendant can be forced to comply with traditional caucus procedures.

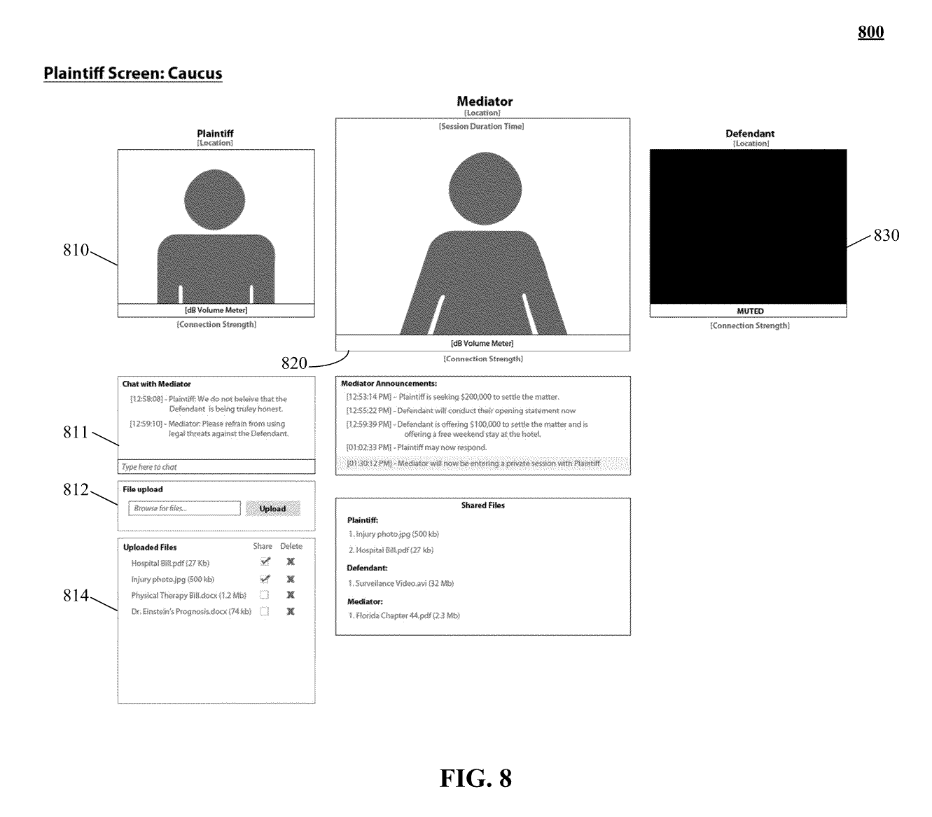

FIG. 8 is a schematic diagram illustrating a plaintiff screen 800 in a caucus session with a mediator associated with an interface for enforcing rule compliance within an online dispute resolution session in accordance with an embodiment of the inventive arrangements disclosed herein. Plaintiff screen 800 can be present in the context of scenario 100, method 200A, 200B, system 300, and embodiment 400. Screen 800 can illustrate a caucus of a three-way online dispute resolution session associated with a screen 500-700, 900. In screen 800, a plaintiff can be presented an audio/video stream of the plaintiff (e.g., portrait 810) and a mediator (e.g., portrait 820). Audio/video stream of a defendant (e.g., portrait 830) can be visually blocked and audio muted. Screen 800 can allow real-time plaintiff interaction with a mediator, a chat element 811, and a mediation tool (e.g., upload dialog 812, file manager 814).

The mediation tool can allow a plaintiff to mark uploaded documents as confidential which can be used securely during a caucus. Upon conclusion of the caucus the mediator can publish the confidential documents to a defendant which can require the plaintiff to accept or deny the defendant's ability to view the documents (e.g., via a notification).

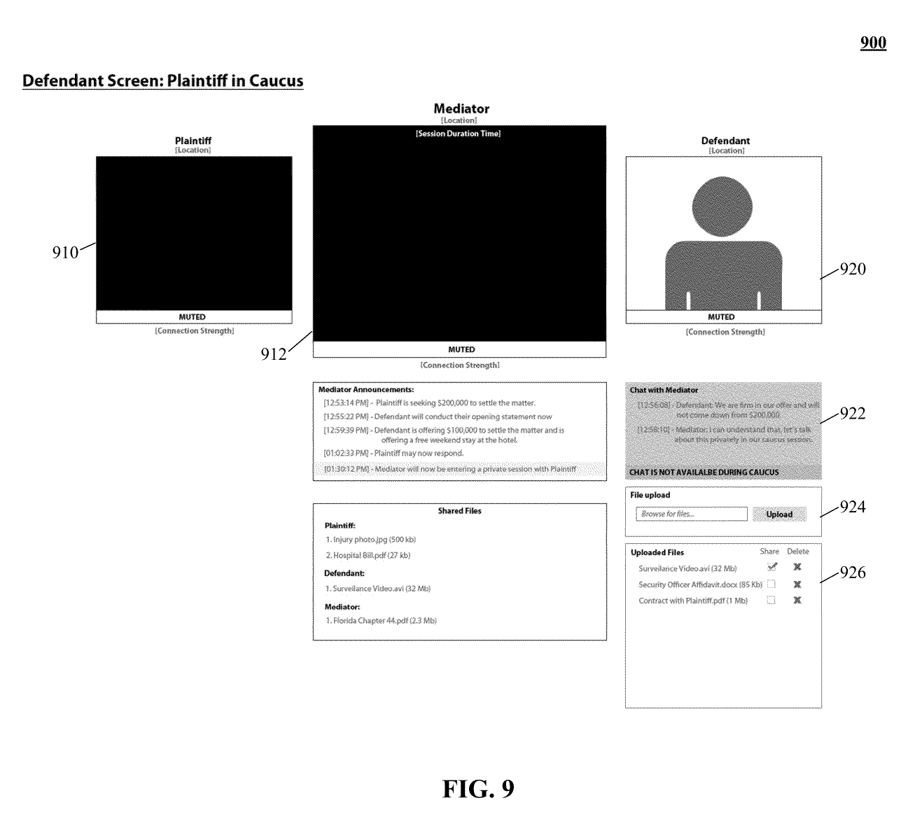

FIG. 9 is a schematic diagram illustrating a defendant screen 900 during a caucus between a plaintiff and a mediator associated with an interface for enforcing rule compliance within an online dispute resolution session in accordance with an embodiment of the inventive arrangements disclosed herein. Screen 900 can illustrate a three-way online dispute resolution session during a caucus associated with a screen 500-800. In screen 900, a defendant can be presented an audio/video stream of the defendant (e.g., portrait 920). Audio/video streams associated with a mediator (e.g., portrait 912) and a plaintiff (e.g., portrait 910) can be visually blocked and audio muted. Screen 900 can restrict interaction with the plaintiff, the mediator, a chat element 922, and a mediation tool (e.g., upload dialog 924, file manager 926). That is, chat element 922, upload dialog, 924, file manager 926, and other mediation tools can be disabled until the caucus between the plaintiff and the mediator is completed.

In one instance, a notification can alert a defendant not participating in a caucus to return to the caucus. In the instance, the notification can include, but is not limited to, a telephone call, a fax, an Short Message Service (SMS), an email, a notification, an audible alert, and the like. It should be appreciated that the notification can include any combination thereof.

The flowchart and block diagrams in the FIGS. 1-9 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A system for rule based online dispute resolution comprising:
an online dispute resolution (ODR) engine able to facilitate a caucus within an alternative dispute resolution of an online dispute resolution session between a neutral participant, a caucused participant, and a non-caucused participant, wherein the alternative dispute resolution is associated with at least one of a legal case and a non-legal case;
a data store configured to persist at least one of a plurality of rules associated with the alternative dispute resolution, the at least one legal case, and a compliance artifact, wherein the plurality of rules is at least one of a law and a legally binding requirement, wherein the legal case is at least one of a civil case and a criminal case, wherein the compliance artifact comprises of at least one mandatory item associated with the plurality of rules and the legal case.

2. The system of claim 1, further comprising:
a caucus component able to selectively suppress transmission of audio/video to the computing device associated with the non-caucused participant and suppress transmission of audio/video of the computing device associated with the non-caucused party to the caucused party during the caucus within the online dispute resolution session;
a selection engine configured to automatically match the neutral participant with the at least one legal case based on a plurality of criteria; and
a compliance element able to determine at least one of the caucus and the online dispute resolution session is conducted in accordance with the compliance artifact.

3. The system of claim 1, further comprising:
a metrics engine configured to collect metrics associated with at least one of the neutral participant, the caucus, and the online dispute resolution session.

4. The system of claim 1, wherein the online dispute resolution session is at least one of an arbitration session and a mediation session.

5. The system of claim 1, wherein the ODR engine provides a recommendation to the neutral for reaching a resolution to the legal case based on at least one of the plurality of rules and the legal case.

6. The system of claim 1, wherein ODR establishes a directory of neutral entities which organize the neutral entities via a plurality of criteria, wherein the criteria is at least one of a category, jurisdiction, and keyword.

7. The system of claim 1, wherein the ODR automatically generates a settlement agreement document based on the resolution of the legal case in the online dispute resolution session.

8. The system of claim 1, wherein the ODR performs a disciplinary action when a mandatory item of the compliance artifact is not performed, wherein the disciplinary action is at least one of a disabling of an online dispute resolution session feature and a neutral participant profile rating downgrade.

9. The system of claim 1, wherein the ODR presents the compliance artifact to the neutral participant, caucused participant, and non-caucused participant during the online dispute resolution session.

10. A method for rule based online dispute resolution comprising
identifying an online dispute resolution session associated with an alternative dispute resolution, wherein the alternative dispute resolution is associated with a legal case, wherein the legal case is associated with a plurality of rules, wherein the plurality of rules is at least one of a law and a legally binding requirement;
performing a rule compliance action upon a selected rule of the plurality of rules to determine the selected rule is satisfied;
when the selected rule is satisfied, optionally alerting a neutral participant participating in the online dispute resolution session that rule compliance is met; and
when the selected rule is not satisfied, performing a disciplinary action, wherein the disciplinary action is at least one of a disabling of a functionality of the online dispute resolution session previously available to the neutral participant and conveying a notification to at least one participant of the online dispute resolution session that the selected rule is mandated.

11. The method of claim 10, wherein the functionality is enabled responsive to rule compliance.

12. The method of claim 10, wherein the plurality of rules is presented within the online dispute resolution session as a mandatory compliance artifact.

13. The method of claim 10, wherein a neutral initiated caucus is established during the online dispute resolution session.

14. The method of claim 13, wherein during the caucus, a caucused party and the neutral participant share a video and audio communication, wherein a non-caucused party is excluded from the communication.

15. The method of claim 10, wherein prior to the online dispute resolution session, a plaintiff and a defendant associated with the legal case is matched to the neutral party based on a plurality of criteria.

16. The method of claim 10, wherein an item of the mandatory compliance artifact is at least one of an arbitration award and a mediated settlement agreement.

17. A computer program product comprising a computer readable storage medium having computer usable program code embodied therewith, the computer usable program code comprising:
computer usable program code stored in a storage medium, if said computer usable program code is executed by a processor it is operable to facilitate a caucus within an alternative dispute resolution of an online dispute resolution session between a neutral participant, a caucused participant, and a non-caucused participant, wherein the alternative dispute resolution is associated with at least one legal case;
computer usable program code stored in a storage medium, if said computer usable program code is executed by a processor it is operable to persist at least one of a plurality of rules associated with the alternative dispute resolution, the at least one legal case, and a compliance artifact, wherein the plurality of rules is at least one of a law and a legally binding requirement, wherein the legal case is at least one of a civil case and a criminal case, wherein the compliance artifact comprises of at least one mandatory item associated with the plurality of rules and the legal case; and
computer usable program code stored in a storage medium, if said computer usable program code is executed by a processor it is operable to perform a plurality of functionality associated with the online dispute resolution session, wherein the plurality of functionality is at least one of a case management functionality, a payment processing functionality, a member directory functionality, an advertising functionality, a file sharing functionality, and a text exchange functionality.

18. The computer program product of claim 17, wherein an item of the mandatory compliance artifact is at least one of an arbitration award and a mediated settlement agreement.

19. The computer program product of claim 17, wherein a disciplinary action is performed when a mandatory item of the compliance artifact is not satisfied, wherein the disciplinary action is at least one of a feature of the online dispute resolution session is disabled, a profile rating associated the neutral is downgraded, and a notification is conveyed to at least one participant associated with the online dispute resolution session.

20. The computer program product of claim 17, wherein the online dispute resolution session is at least one of an arbitration session and a mediation session.
